(19) United States
(12) Patent Application Publication
(10) Pub. No.: US 2012/0099745 A1
(43) Pub. Date: Apr. 26, 2012

(54) PORTABLE ELECTRONIC DEVICE HAVING OBLIQUE SOUND OUTPUT ARRANGEMENT

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 12/973,802

(22) Filed: Dec. 20, 2010

(30) Foreign Application Priority Data
Oct. 21, 2010 (CN) 201010514505.1

(51) Int. Cl. H04R 1/02

(52) U.S. Cl. 381/182; 381/388

(57) ABSTRACT

An exemplary portable electronic device includes a flat shell, two speakers received in the shell, and a display panel. The shell includes a front plate at a front side thereof, a rear plate at a rear side thereof, and a sidewall between the front plate and the rear plate. The display panel is arranged at the front side of the shell. The rear plate has a center flat portion substantially parallel to the display panel and two angled portions at two opposite sides of the flat portion. Two sets of sound emission holes are respectively defined in the two angled portions of the rear plate of the shell. The two speakers are located corresponding to the two sets of sound emission holes with a front side of each facing a corresponding set of sound emission holes.

### BACKGROUND

1. Technical Field

The disclosure generally relates to portable electronic devices, and more particularly to a portable electronic device configured to provide optimum sound output for one or more speakers thereof.

2. Description of Related Art

A portable electronic device, such as a mobile phone, a tablet computer, a handheld game console, a personal digital assistance (PDA) or an MP4 (MPEG audio layer 4) player, usually has a built-in speaker for users to listen to music and play games. To obtain a high-quality sound effect, sound emission holes for the speaker are desired to be defined in a front side of the portable electronic device.

However, a display panel and some operating keys are usually arranged at the front side of the portable electronic device. The sound emission holes defined in the front side of the portable electronic device limit the area available for the display panel and the operating keys. To avoid this problem, sound emission holes of some portable electronic devices are instead defined in peripheral walls of the portable electronic device. Referring to FIG. 6, a commonly used portable electronic device includes a shell, and two speakers arranged in the shell. The two speakers are located at two adjacent corners of the shell, respectively. Two sets of sound emission holes are defined in a peripheral wall of the portable electronic device, adjacent to two corners of the portable electronic device. Each set of sound emission holes is located adjacent to a corresponding speaker. However, the sound emission holes are disposed at a lateral side of the speaker, not a front (sound output) side of the speaker. Thus the intermediate frequency and high frequency range of the sound output from the portable electronic device is weakened, and users cannot fully enjoy the sound when they listen to music or play games. Further, the sound emission holes defined in the peripheral wall may be covered by a user's hands, thereby reducing the sound pressure.

What is needed, therefore, is a portable electronic device to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead placed upon clearly illustrating the principles of the present embodiments. Moreover, in the drawings, like reference numerals designate corresponding parts throughout the views.

FIG. 1 is an isometric, assembled view of a portable electronic device in accordance with an exemplary embodiment of the present disclosure, showing the portable electronic device face down.

FIG. 2 is an exploded view of the portable electronic device of FIG. 1, but showing the portable electronic device face up, and omitting a plurality of components inside a shell of the portable electronic device.

FIG. 3 is a plan view of the portable electronic device of FIG. 1, showing a rear of the portable electronic device.

FIG. 4 is a side plan view of the portable electronic device of FIG. 1, but showing the portable electronic device face up and resting on a horizontal surface.

FIG. 5 is an enlarged view of a circled portion V of FIG. 4.

FIG. 6 is a top plan view of a commonly used portable electronic device.

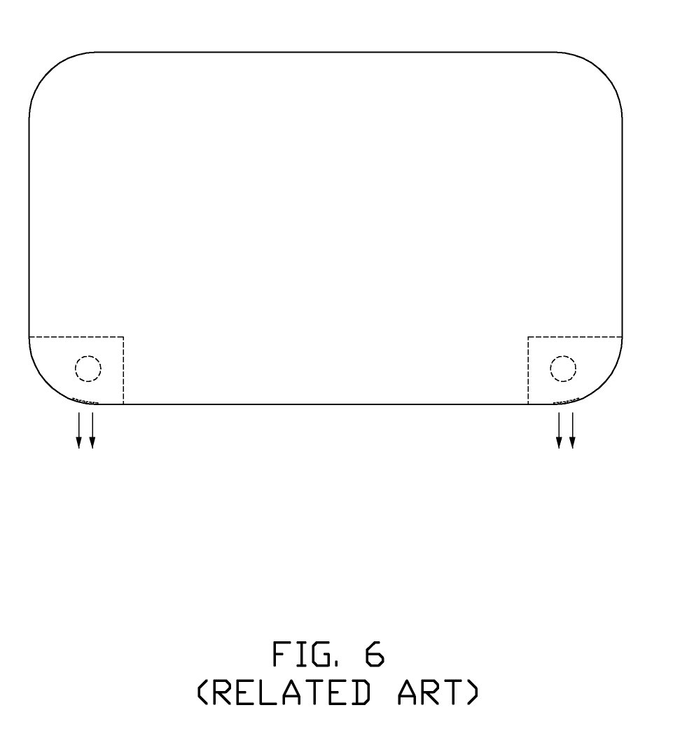

### DETAILED DESCRIPTION

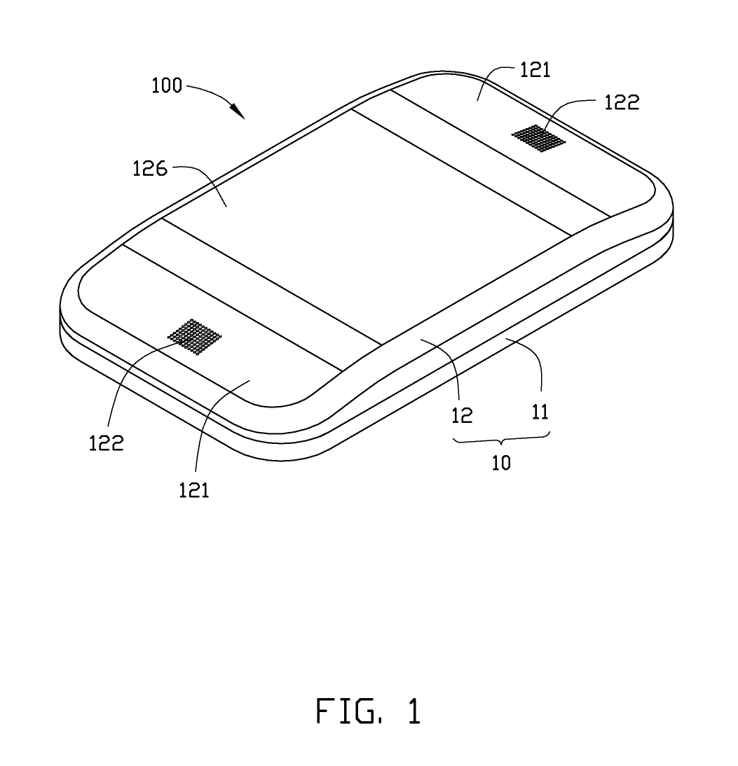

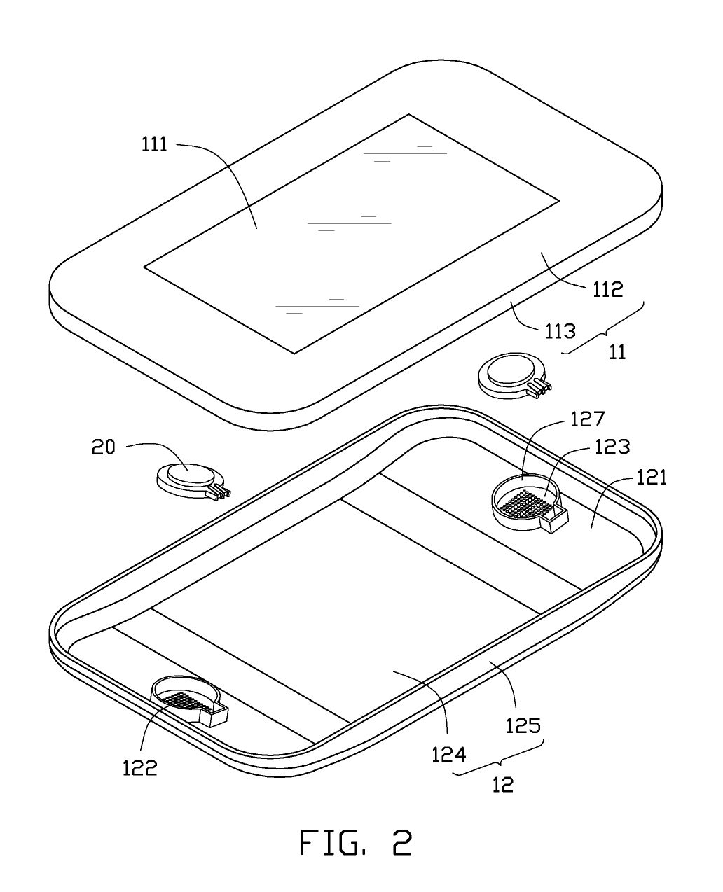

Referring to FIGS. 1-2, a portable electronic device 100 according to an exemplary embodiment of the present disclosure is shown. The portable electronic device 100 can be a mobile phone, a tablet computer, a handheld game console, a PDA, an MP4 player, or other handheld electronic device.

The portable electronic device 100 includes a then, generally flat shell 10 in which components of the portable electronic device 100, such as a circuit board, a central processing unit, a battery, a multimedia module and two speakers 20, are received. The shell 10 includes a front cover 11, and a rear cover 12 connected to the front cover 11. The front cover 11 and the rear cover 12 cooperatively define a receiving space therebetween for receiving the components of the portable electronic device 100.

The front cover 11 includes a substantially rectangular front plate 112 and a sidewall 113 extending from a peripheral edge of the front plate 112 towards the rear cover 12. The portable electronic device 100 has a display panel 111 in a front side of the shell 10. The display panel 111 is located at a center of the front plate 112.

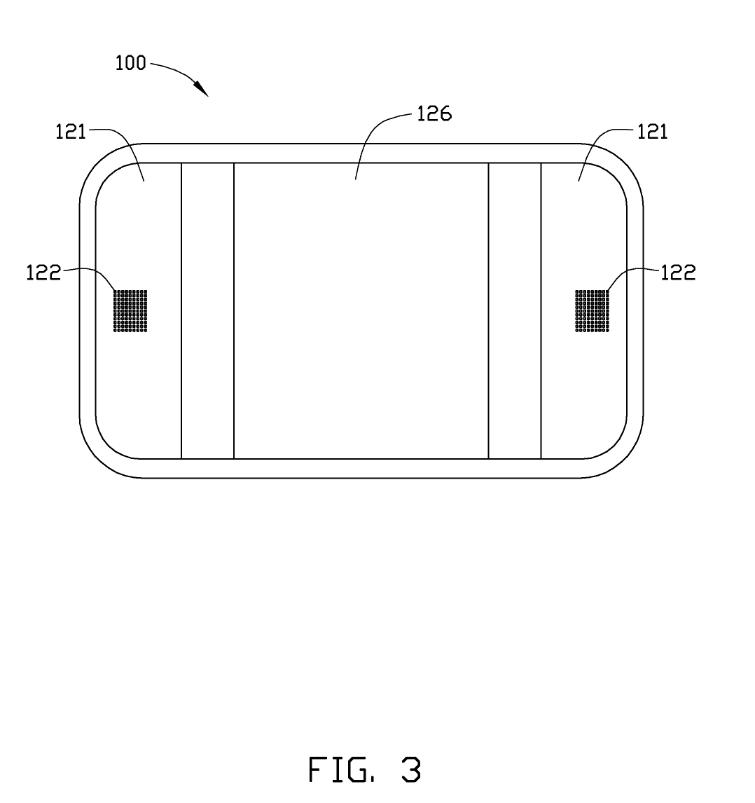

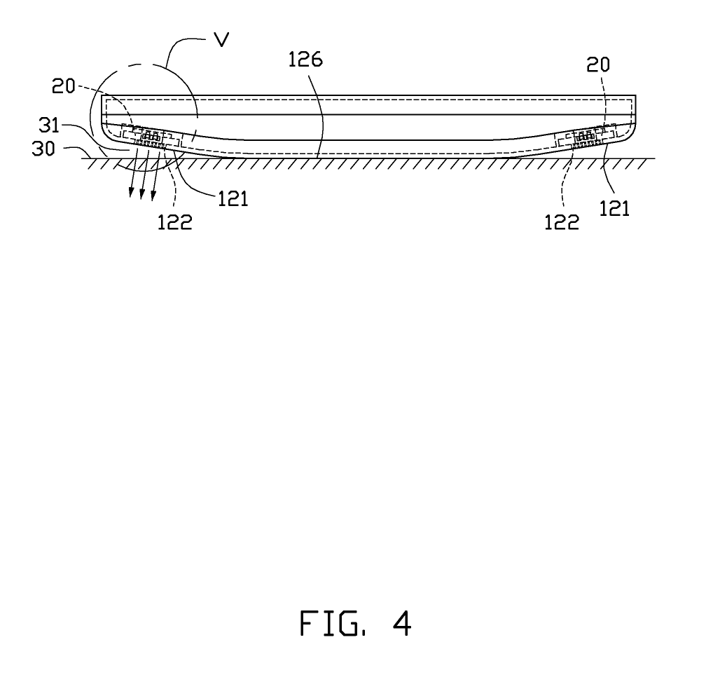

Referring also to FIG. 3, the rear cover 12 includes a substantially rectangular rear plate 124 and a sidewall 125 extending from a peripheral edge of the rear plate 124 towards the front cover 11. The rear plate 124 has a center flat portion 126 substantially parallel to the display panel 111, and two angled portions 121 at two opposite sides of the flat portion 126. The two angled portions 121 extend upwardly and outwardly from two opposite sides of the flat portion 126 (see FIG. 4). Each angled portion 121 is located between the flat portion 126 and a corresponding short side of the sidewall 125 of the rear cover 12. The angled portion 121 defines a set of sound emission holes 122 therein. Each angled portion 121 can have a planar or curved outer surface. In the illustrated embodiment, the angled portion 121 has a planar outer surface. Each set of sound emission holes 122 is located in approximately a center of the corresponding angled portion 121, halfway along a longitudinal axis of the angled portion 121. In this embodiment, the longitudinal axis of the angled portion 121 is parallel to a short side of the portable electronic device 100. The sound emission holes 122 of the angled portion 121 are arranged in a rectangular array. In other embodiments, the sound emission holes 122 of the angled portion 121 can be arranged in a circular array.

Referring to FIG. 4, when the shell 10 is disposed on a horizontal surface 30 with the display panel 111 face up, a wedge-shaped gap 31 is defined between each angled portion 121 and the horizontal surface. Sound from each set of sound emission holes 122 can travel through the wedge-shaped gap 31 to the ambient environment, whereby the sound volume and quality provided by the portable electronic device 100 is enhanced.

Each angled portion 121 of the rear plate 124 of the rear cover 12 forms an annular wall 127 on an inner surface thereof, corresponding to the respective set of sound emission holes 122. The angled portion 121 and the annular wall 127 cooperatively define a sound chamber 123 therebetween for receiving a corresponding speaker 20. The sound chamber 123 is substantially columnar (or disk-shaped). Each set of sound emission holes 122 is defined in a region of the angled portion 121, which region can be considered to be surrounded by the annular wall 127. A ratio of an area of the set of sound emission holes 122 to an area of the region surrounded by the annular wall 127 is not less than 20%.

The two speakers 20 are arranged in the shell 10, and are located corresponding to the sets of sound emission holes 122 of the two angled portions 121. Each speaker 20 is received in a corresponding sound chamber 123, with a front (sound output) side of the speaker 20 (i.e., a side of the speaker 20 at which the diaphragm of the speaker 20 is located) facing the corresponding set of sound emission holes 122 of the shell 10.

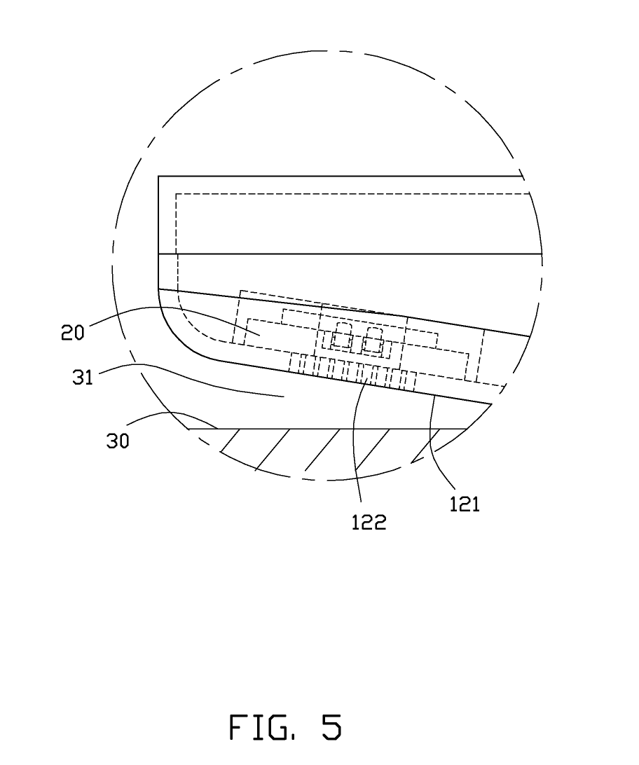

Referring also to FIG. 5, when each speaker 20 is in operation, sound emitted by the speaker 20 travels along the corresponding set of sound emission holes 122, and then to the ambient environment. An angle formed between a direction of maximum sound intensity of the speaker (indicated by the arrows in FIG. 4, i.e., an axial direction of each sound emission hole) and a plane of the display panel 111 is an acute angle. In other words, the direction of maximum sound intensity is neither parallel nor perpendicular to the plane of the display panel 111. Preferably, the angle between the direction of maximum sound intensity and the plane of the display panel 111 is selected from the range of from 30° to 60°.

The shell 10 has a symmetrical structure. The two angled portions 121 of the rear plate 124 are symmetrically arranged at the rear side of the shell 10. In other embodiments, the rear plate 124 can provide four angled portions 121 at the rear side of the shell 10, with all four angled portions 121 adjacent to the sidewall 125 thereof. Each angled portion 121 defines a set of sound emission holes 122 therein. Accordingly, four speakers 20 are provided in the shell 10, with each speaker 20 located corresponding to a respective set of sound emission holes 122.

In the portable electronic device 100, each set of sound emission holes 122 is defined in the angled portions 121 of the rear plate 124 of the shell 10. Thereby, the front side of the corresponding speaker 20 can be arranged directly adjacent to the sound emission holes 122. Compared with a conventional portable electronic device in which sound emission holes are disposed at a lateral side of a speaker, the portable electronic device 100 has significantly strengthened intermediate frequency and high frequency ranges (particularly 5 KHz to 20 KHz) of output sound. Therefore, the portable electronic device 100 permits its users to fully enjoy the sound when they listen to music or play games. Further, the portable electronic device 100 helps prevent the sound emission holes 122 from being covered by a user's hands, while still allowing convenient placement and arrangement of the display panel 111 and operating keys thereof. That is, the portable electronic device 100 avoids inadvertent and unwanted reduction of sound pressure.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A portable electronic device comprising:
a flat shell comprising a front plate at a front side thereof, a rear plate at a rear side thereof, and a sidewall between the front plate and the rear plate, at least one set of sound emission holes being defined in the rear plate and located adjacent to the sidewall of the shell;
a display panel arranged at the front side of the shell; and
at least one speaker received in the shell and located corresponding to the at least one set of sound emission holes, an angle formed between a direction of maximum sound intensity of the at least one speaker and the display panel being an oblique angle.

2. The portable electronic device of claim 1, wherein the rear plate has a center flat portion substantially parallel to the display panel and at least one angled portion adjacent to the sidewall of the shell, the at least one angled portion slantingly extending from an edge of the flat portion towards the front plate of the shell, the at least one set of sound emission holes being defined in the at least one angled portion of the rear plate.

3. The portable electronic device of claim 2, wherein the angle formed between the direction of maximum sound intensity of the at least one speaker and the display panel is selected from the range of from 30° to 60°.

4. The portable electronic device of claim 2, wherein the at least one set of sound emission holes are located a center of the at least one angled portion along a longitudinal axis of the angled portion.

5. The portable electronic device of claim 2, wherein when the shell is disposed on a horizontal surface with the display panel facing up, a wedge-shaped gap is defined between each angled portion and the horizontal surface.

6. The portable electronic device of claim 2, wherein the at least one angled portion comprises two angled portions slantingly extending from two opposite sides of the flat portion towards the front plate of the shell, the at least one set of sound emission holes comprising two sets of sound emission holes respectively defined in the two angled portions.

7. The portable electronic device of claim 6, wherein the two angled portions are symmetrically formed on the rear plate of the shell.

8. The portable electronic device of claim 6, wherein an area ratio of each set of sound emission holes is not less than 20%.

9. The portable electronic device of claim 1, wherein the at least one speaker is received in a sound chamber defined in the shell, a sound output side of the at least one speaker facing the least one set of emission holes of the shell.

10. The portable electronic device of claim 1, wherein each set of sound emission holes is arranged in a rectangular array.

11. A portable electronic device comprising:
a flat shell comprising a front plate at a front side thereof, a rear plate at a rear side thereof, and a sidewall between the front plate and the rear plate;
two speakers received in the shell; and
a display panel arranged at the front side of the shell, the rear plate having a center flat portion substantially parallel to the display panel and two angled portions at two opposite sides of the flat portion, two sets of sound emission holes being respectively defined in the two angled portions of the rear plate of the shell, the two speakers being located corresponding to the two sets of sound emission holes with a sound output side of each speaker facing a corresponding set of sound emission holes.

12. The portable electronic device of claim 11, wherein each set of sound emission holes is located a center of a corresponding angled portion along a longitudinal axis thereof.

13. The portable electronic device of claim 11, wherein the rear plate of the shell forms an annular wall on an inner surface of each angled portion thereof at a position corresponding to each set of sound emission holes, the annular wall and the angled portion of the rear plate cooperatively defining a sound chamber therebetween, each of the two speakers being received in a corresponding sound chamber.

14. The portable electronic device of claim 13, wherein each set of sound emission holes is defined in a region of the angled portion surrounded by the annular wall of the angled portion.

15. The portable electronic device of claim 13, wherein the sound chamber is substantially columnar.

16. The portable electronic device of claim 13, wherein a ratio of the total area of the set of emission holes to an area of the region surrounded by the annular wall is not less than 20%.

17. The portable electronic device of claim 11, wherein each set of sound emission holes is arranged in a rectangular array.

18. The portable electronic device of claim 11, wherein the two sets of sound emission holes are symmetrically arranged at the rear plate of the shell.

19. A portable electronic device comprising:
a shell comprising a front plate, a rear plate, and a sidewall between the front plate and the rear plate, the rear plate comprising a portion obliquely oriented relative to the front plate, and the oblique portion having a set of sound emission holes defined therein;
a display panel at the front side of the shell; and
a speaker received in the shell, a sound output side of the speaker facing the set of sound emission holes.

20. The portable electronic device of claim 19, wherein the oblique portion defines a tapered space outside of the rear plate of the portable electronic device, with the tapered space being nearer to the front plate than a rearmost extremity of the rear plate.
